(19) United States
(12) Patent Application Publication
(10) Pub. No.: US 2025/0080357 A1
(43) Pub. Date: Mar. 6, 2025

(54) SYSTEM AND METHODS FOR 3D GEOMETRY EVALUATION USING VERTEX DISTANCE FROM CENTER AND MESH TRIANGLE VERTEX DISTANCE HASHING

(71) Applicant: Marcus David Adams, Cincinnati, OH (US)

(72) Inventor: Marcus David Adams, Cincinnati, OH (US)

(21) Appl. No.: 18/818,862

(22) Filed: Aug. 29, 2024

Related U.S. Application Data
(60) Provisional application No. 63/580,075, filed on Sep. 1, 2023.

(51) Int. Cl. H04L 9/32; G06T 17/20

(52) U.S. Cl. CPC H04L 9/3236; G06T 17/20

(57) ABSTRACT

The present invention provides improved systems and methods for 3D geometry evaluation using vertex distance from center and mesh triangle vertex distance hashing. The present invention allows the generation of a unique hash that is immune to scale, position, orientation, and being inverted along any axis. This allows for the ability to store a single unique hash for each reference geometry that is calculated in advance, generate the unique hash for a search geometry, and then search for matching hash values. The actual geometries do not have to be stored, and only one string value, the hash value, is being searched.

### CROSS-REFERENCE TO RELATED APPLICATION

This application claims the benefit of priority of U.S. provisional application No. 63/580,075, filed Sep. 1, 2023, the contents of which are herein incorporated by reference.

### BACKGROUND OF THE INVENTION

Given an unreferenced geometry, it is difficult to determine if the unreferenced geometry matches any one of many reference geometries if the reference geometries have different orientations, positions, or are inverted along any axis. Conventional systems are unable to match a geometry with reference geometries if the orientation is different in any axis or inverted along any axis. Conventional systems also lack the ability to generate a single unique hash for a geometry to speed up searching and reduce storage requirements. While using hashing algorithms to speed up searches is not new, there is currently no hashing algorithm that can generate a single, unique hash for the same geometry regardless of its scale, orientation, position, or being inverted along any axis.

The present invention relates to improved systems and methods for 3D geometry evaluation using vertex distance from center and mesh triangle vertex distance hashing. In a preferred embodiment, the present invention allows the generation of a unique hash that is immune to scale, position, orientation, and being inverted along any axis. This allows for the ability to store a single unique hash for each reference geometry that is calculated in advance, generate the unique hash for a search geometry, and then search for matching hash values. The actual geometries do not have to be stored, and only one string value, the hash value, is being searched.

### BRIEF DESCRIPTION OF THE DRAWINGS

FIG. 1 depicts a flowchart in accordance with an aspect of a preferred embodiment of the present invention.

FIG. 2 depicts a schematic view of an exemplary geometry to be evaluated in accordance with an aspect of a preferred embodiment of the present invention.

FIG. 3 depicts an exemplary view of an extraction of vertices in accordance with an aspect of a preferred embodiment of the present invention.

FIG. 4 depicts a schematic view of calculating a center point in accordance with an aspect of a preferred embodiment of the present invention.

FIG. 5 depicts a schematic view of the distances from vertices to a center point in accordance with an aspect of a preferred embodiment of the present invention.

FIG. 6 depicts a schematic view of determined mesh triangles in accordance with an aspect of a preferred embodiment of the present invention.

FIG. 7 depicts a schematic view of mesh triangle vertex distances in accordance with an aspect of a preferred embodiment of the present invention.

### SUMMARY OF THE INVENTION

In one aspect of the present invention, there is disclosed improved systems and methods for 3D geometry evaluation using vertex distance from center and mesh triangle vertex distance hashing.

In another aspect of the present invention, the present invention provides a method of generating a single, unique hash for a given geometry, regardless of its scale, orientation, position, or being inverted in any axis.

The improved systems and methods of the present invention are novel and innovative solutions that address certain of the aforementioned challenges. These and other features, aspects and advantages of the present invention will become better understood with reference to the following drawings, description and claims.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As stated above, it is difficult to determine if an unreferenced geometry matches any one of many reference geometries if the reference geometries have different orientations, positions, or are inverted along any axis. Conventional systems and methods are unable to match geometries with reference geometries that differ in any scale or position and in limited axes of orientation or inversion. While using hashing algorithms to speed up searches is not new, there is currently no hashing algorithm that can generate a single, unique hash for the same geometry regardless of its scale, orientation, position, or being inverted along any axis. Other methods that require matching multiple values or storing reference geometries for comparison and are still unable to match geometries that differ in any orientation. Other methods also require storage of reference geometries for individual comparison. Unlike these conventional systems and methods, the present invention does not require storage of reference geometries for comparison.

The present invention solves these and other problems with conventional systems and methods. In a preferred embodiment, the present invention provides a method of generating a single, unique hash for a given geometry, regardless of its scale, orientation, position, or being inverted in any axis.

In a preferred embodiment, the present invention allows the generation of a unique hash that is immune to scale, position, orientation, and being inverted along any axis. This allows for the ability to store a single unique hash for each reference geometry that is calculated in advance, generate the unique hash for a search geometry, and then search for matching hash values. The actual geometries do not have to be stored, and only one string value, the hash value, is being stored and searched. Also, the present invention produces a single, unique hash for a given geometry that represents the geometry itself, and is not dependent on the geometry's scale, position, orientation, and inversion along any axis.

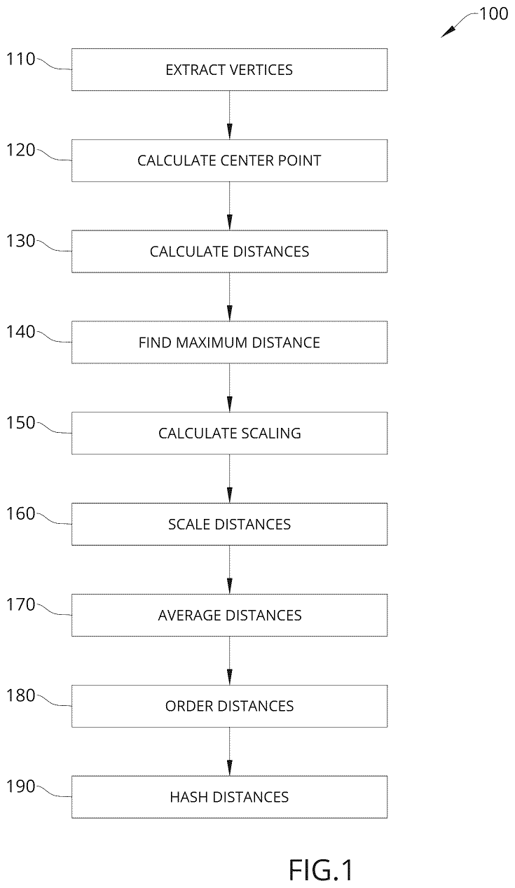

FIG. 1 depicts a flowchart in accordance with an aspect of a preferred embodiment of the present invention. As seen in FIG. 1, flowchart 100 comprises extracting positions of all vertices from the geometry at step 110. Next, the center point of the geometry is calculated at step 120, and the distance from each vertex to the center point and the distance between each vertex of each mesh triangle is calculated at step 130. The largest calculated distance value is determined at step 140, and then a scaling factor is calculated at step 150. Each distance value is multiplied by a scaling factor at step 160, and the distance values are averaged at step 170. The averaged distance values are then ordered at step 180, and finally the ordered and averaged distance values are hashed with a cryptographic hashing algorithm at step 190.

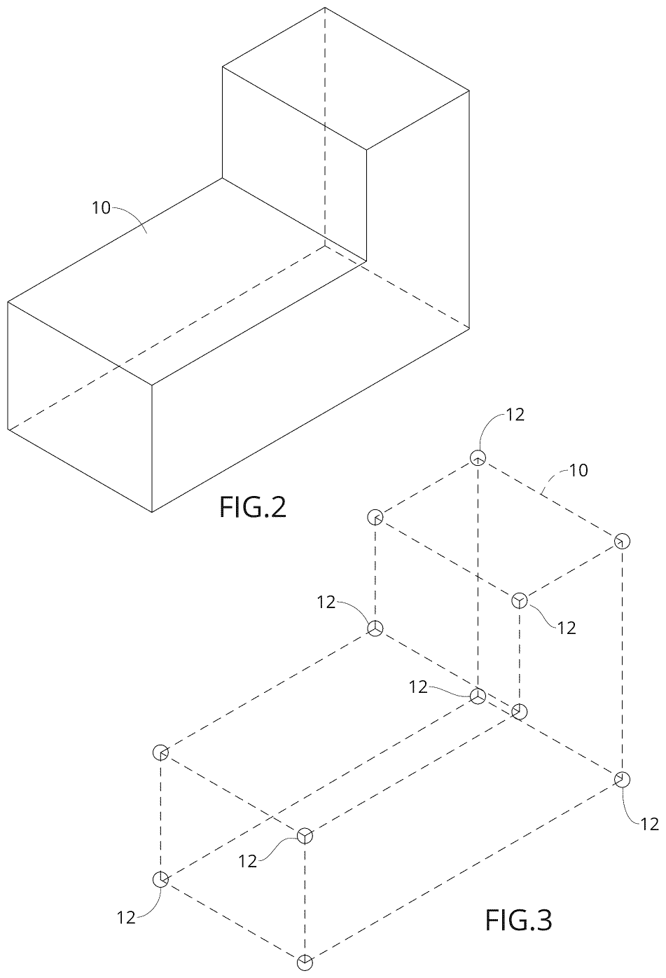

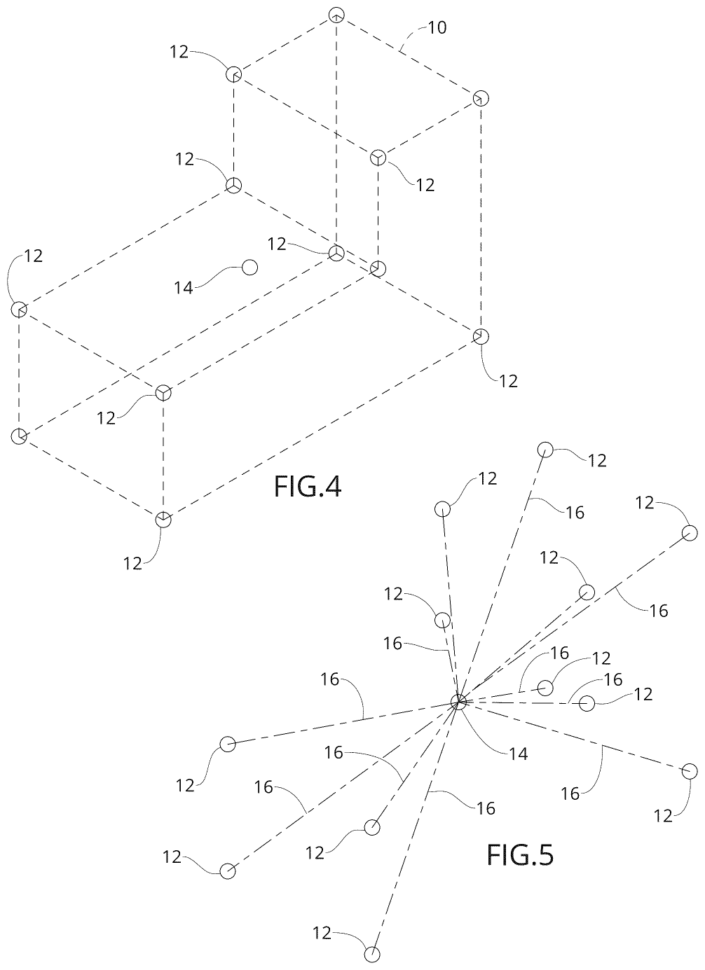

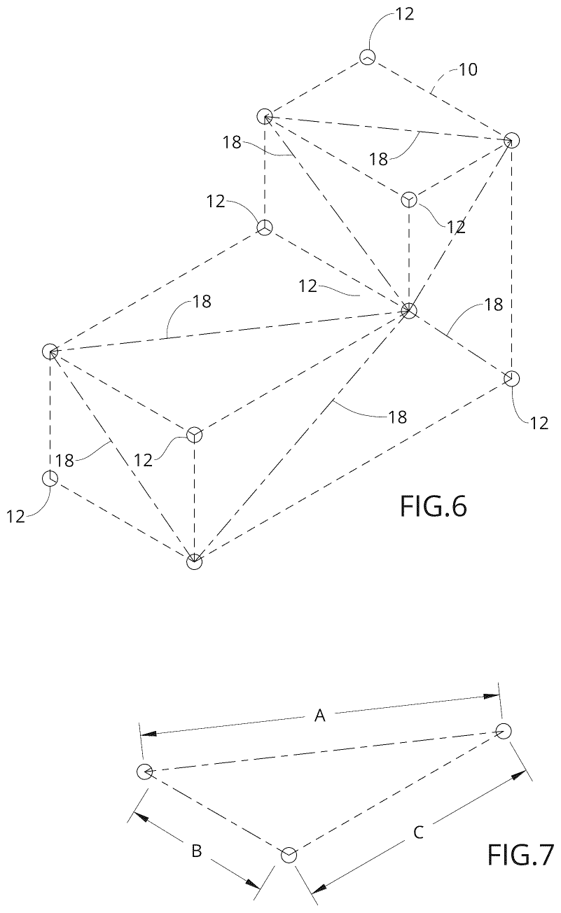

FIGS. 2-7 depict applying aspects of the steps of FIG. 1 to an exemplary geometry 10. FIG. 2 depicts a schematic view of an exemplary geometry 10 to be evaluated. FIG. 3 depicts a schematic view showing the extraction of vertices 12 from geometry 10. FIG. 4 depicts a schematic view of calculating the center point 14, and FIG. 5 depicts a schematic view of calculating the distances 16 from the center point 14 to the vertices 12. FIG. 6 depicts a schematic view of the determined mesh triangles 18. FIG. 7 depicts a schematic view of the distance between each vertex of the mesh triangles, where A is the first distance between the vertices, B is the second distance between the vertices, and C is the third distance between the vertices.

The steps as described above are sequential and performed in order on the vertex position values that are extracted in step 110, iterating through each vertex position. Steps 130 and 140 can be performed in the same iteration because the largest distance value can start at zero and be replaced with any larger value as each distance from the vertex to the center point is calculated. The vertices in a mesh geometry are ordered such that each of the three vertices comprises a single mesh triangle. Therefore, the distance between each vertex of each mesh triangle can be calculated during the same iteration. The scale factor for step 150 is calculated to scale the maximum distance to an arbitrary but predefined scale. Step 160 normalizes the distance values to the predefined scale. Step 170 maps each value to an arbitrary but predefined limited number of values based on the range of the value. This averages the values to accommodate for rounding errors that can occur when changing the scale, position, or orientation of a geometry. Steps 160 and 170 can be performed in the same iteration because the scale factor can be applied to a distance, then the resulting scaled distance value can be immediately averaged with the lookup table. The order method is arbitrary but predefined, with the only stipulation given that the same set of values when ordered has the resulting set in the same order. In step 190, the ordered values are fed through an arbitrary but predefined cryptographic hashing algorithm in order, yielding the resulting hash value.

By following the above listed steps, in the order listed, a single, unique hash can be generated for a geometry, which will yield the same final hash value regardless of the geometry's scale, position, orientation, and being inverted along any axis. Once the scale is normalized, the relationship between each vertex and the center point of the geometry does not change in relation to orientation, position, and being inverted along any axis. Once the scale is normalized, the distances between the three vertices for each mesh triangle is also unaffected by orientation, position, or being inverted. Averaging the distance values by converting them with a lookup table based on the distance value's range solves rounding issues by normalizing the values. Reducing the number of values in the set with the lookup table reduces boundary issues that can occur when averaging, where one value due to loss of precision when rounding may round up to one value in one case, but round down to another value in another case. To generate identical unique hash values from the same set of data using a cryptographic hashing algorithm, the same data must be fed through the algorithm in the same order. The ordering of the averaged distance values ensures that the values are always processed through the hashing algorithm in the same order. The relationship of the vertices to each other in the original geometry is inconsequential. The relationship of the mesh triangles to each other in the original mesh geometry is inconsequential. Neighboring triangles and vertices are inconsequential. Congruency between any vertex or triangle with each other is inconsequential. The center point is only calculated and is not part of the original geometry. This invention does not consider geometry perimeter lengths or slices of the geometry along any axis.

The means disclosed herein consist of the above-listed steps. The necessary steps are utilizing the center point of the geometry and measuring the distances between the vertices to the center point and measuring the distance between each vertex of each mesh triangle to generate a single unique hash that is immune to changes in scale, position, orientation, and being inverted along any axis. Modifying the remaining steps affects the effectiveness of the invention to produce a single unique hash for a given geometry. While the predefined target scale factor is arbitrary as long as the factor is constant, some target scale factors may be found that perform better than others. While averaging the values with a lookup table, the number of values in the lookup table and the ranges are arbitrary as long as they are constant. The number of values in the lookup table and the ranges may be adjusted for a tradeoff between hash uniqueness and occurrence of boundary issues when averaging values to accommodate rounding issues. More values and smaller ranges in the lookup table may provide more uniqueness, meaning less hash collisions where different geometries produce the same hash, but it also causes more occurrences where the same geometry produces different hashes due to rounding from changes in scale, position, or orientation. Some lookup tables may perform better than others. Using a lookup table that mimics the Fibonacci series may perform better than others.

The ordering method of the averaged distance values does not affect the ability to generate a single unique hash for a given geometry, as long as the ordering method is consistent between processes, yet some ordering methods may be found that perform better than others. It may be discovered that the same solution can be resolved using the steps in a different order or removing steps. Further efficiencies may be discovered that require less iterations, and variations for each step might be discovered that solve the same problem.

Utilizing the calculated center point of a geometry and its positional relationship with the vertices in the geometry, and the distance between each vertex of each mesh triangle, steps may be modified, reconfigured, shuffled, added, or removed, that may create a unique hash for a given geometry that is immune to changes in scale, position, orientation, and being inverted in any axis to varying effect. It is possible to generate multiple hashes for each geometry using different lookup tables, sacrificing the efficiency of a single hash for a more robust and less efficient matching that is less susceptible to the boundary issues caused from rounding. The ordering of the distance values would not be necessary if some algorithm to generate a single value were applied to the values that is not order dependent, such as mathematical addition, which would sacrifice uniqueness of the generated hash. There may be cryptographic algorithms that are not dependent on the order of the data. It may be possible to use only a subset of the vertices for a faster calculation, again by sacrificing uniqueness. Rather than calculating distances between the position of the center point and vertices, some method may be developed to use a value that is calculated off of the vertex positions to achieve a similar result, such as using midpoints between the two. Instead of calculating the center point, it's possible to calculate the longest distance between any of the vertices in the geometry, then performing the above steps to calculate a hash, substituting the center point for each of the two vertices.

Ordering or another method could then be used to determine which of the hashes to keep, such as the smallest hash value, or the hashes could be ordered and combined. Conversely, the shortest distance between any two points could be used. This process could be inefficient if multiple vertices shared the same distance, such as the vertices in a sphere. Also, it is likely that the chosen vertices would change due to rounding issues.

By following the above-listed steps, a single, unique hash can be generated for a given geometry. The generated hash value will be the same for the given geometry regardless of the given geometry's scale, position, orientation, and inversion along any axis. By precomputing hashes using the above-listed steps for a set of reference geometry, it is possible to search for matching geometries that may differ in scale, position, orientation, and inversion along any axis. By generating a single, unique hash per geometry, it is possible to perform the search efficiently.

Additionally, the invention can be used to develop software that generates a single unique hash for a given geometry and search a database of reference geometries for a match by comparing the generated hash with precomputed hash values, especially without having to store the geometries themselves.

The invention produces a single, unique hash for a given geometry that represents the geometry itself, and is not dependent on the geometry's scale, position, orientation, and inversion along any axis.

It should be understood, of course, that the foregoing relates to exemplary embodiments of the invention and that modifications may be made without departing from the spirit and scope of the invention as set forth in the following claims.

What is claimed is:

1. A method for generating a unique hash value for a given geometry, the method comprising:
extracting a position of each vertex of the geometry;
calculating a center point of the geometry;
calculating a distance from each vertex to the center point;
determining a mesh triangle among three vertices of the geometry;
calculating a distance between each vertex of each mesh triangle;
determining a largest calculated distance value;
calculating a scaling factor;
multiplying each distance value by the scaling factor;
averaging the distance values;
ordering the averaged distance values; and
hashing the ordered and averaged distance values with a cryptographic hashing algorithm.

2. The method of claim 1, wherein each step is sequential and performed in order on each extracted vertex position value, iterating through each vertex position.

3. The method of claim 1, wherein calculating a distance between each vertex of each mesh triangle is performed in the same iteration.

4. The method of claim 1, wherein the largest calculated distance value starts at zero and is replaced with any larger value as each distance from the vertex to the center point is calculated.

5. The method of claim 1, wherein the vertices in a mesh geometry are ordered such that each of the three vertices comprises a single mesh triangle.

6. The method of claim 1, wherein the distance between each vertex of each mesh triangle is calculated during the same iteration.

7. The method of claim 1, wherein the scale factor is calculated to scale the maximum distance to an arbitrary but predefined scale.

8. The method of claim 1, wherein the distance values are normalized to a predefined scale.

9. The method of claim 1, wherein each averaged distance value is mapped to an arbitrary but predefined limited number of values based on a range of the value.

10. The method of claim 1, wherein multiplying each distance value by the scaling factor and averaging the distance values is performed in the same iteration and the resulting scaled distance value is averaged with a lookup table.

11. The method of claim 1, the ordered values are fed through an arbitrary but predefined cryptographic hashing algorithm in order, yielding a hash value.
